(19) United States
(12) Patent Application Publication
(10) Pub. No.: US 2010/0220577 A1
(43) Pub. Date: Sep. 2, 2010

(54) OPTICAL HEAD DEVICE, OPTICAL INFORMATION RECORDING/REPRODUCING DEVICE, AND OPTICAL INFORMATION RECORDING/REPRODUCING METHOD

(76) Inventor: Ryuichi Katayama, Tokyo (JP)

Correspondence Address: Mr. Jackson Chen, 6535 N. STATE HWY 161, IRVING, TX, 75039, US

(21) Appl. No.: 12/529,782

(22) PCT Filed: Feb. 8, 2008
(86) PCT No.: PCT/JP2008/052131

§ 371 Date: Oct. 6, 2009

(30) Foreign Application Priority Data
Mar. 6, 2007 (JP) 2007-055263

(51) Int. Cl. G11B 7/135

(52) U.S. Cl. 369/112.16

(57) ABSTRACT

Polarization direction switching elements do not change the polarization direction of incoming light, in the case where a disc is an optical recording medium conforming to the HD DVD standards. At this time, light outputted from a semiconducted laser is collected on the disc by an objective lens, and reflection light from the disc is received by a light detector. In the case where the disc is an optical recording medium conforming to the BD standards, the polarization direction switching elements change the polarization directed of the incoming light by ninety degrees. At this time, light outputted from the semiconductor laser is collected on the disc by the objective lens, and reflection light from the disc is received by the light detector. Liquid crystal lenses correct spherical aberrations on an outgoing path and a returning path.

### TECHNICAL FIELD

The present invention relates to an optical head device and an optical information recording/reproducing device for recording and reproducing on two types of optical recording media having different conditions in a used optical system. This application claims priority based on Japanese Patent Application No. 2007-055263, and the disclosure of Japanese Patent Application No. 2007-055263 is incorporated herein by reference.

### BACKGROUND ART

A recording density in an optical information recording/reproducing device is in inverse proportion to a square of a diameter of a condensed spot formed on an optical recording medium by an optical head device. That is, the smaller the diameter of the condensed spot is, the larger the recording density becomes. The diameter of the condensed spot is in proportion to a wavelength of a light source in the optical head device, and is in inverse proportion to a numerical aperture of an objective lens. That is, the shorter the wavelength of the light source is and the larger the numerical aperture is, the smaller the diameter of the condensed spot becomes. According to the standard for CD (compact disc) having 650 Mbyte in capacity, the wavelength of the light source is approximately 780 nm and the numerical aperture is 0.45. Additionally, according to the standard for DVD (digital versatile disk) having 4.7 Gbyte in capacity, the wavelength of the light source is approximately 650 nm and the numerical aperture is 0.6.

Meanwhile, when the optical recording medium inclines to the objective lens, a shape of the condensed spot is distorted due to a coma aberration to deteriorate a recording and reproducing characteristic. The coma aberration is in inverse proportion to the wavelength of the light source, is in proportion to the cube of the numeric aperture, and is in proportion to a thickness of a protection layer in the optical recording medium. For this reason, in a case where thicknesses of the protection layers are the same, the shorter the wavelength of the light source is and the larger the numerical aperture is, the smaller a margin of inclination of the optical recording medium becomes. Accordingly, in a standard in which the wavelength of the light souse is set to be shorter and the numerical aperture is set to be larger for improving the recording density, the thickness of the protection layer is set to be thin as needed in order to ensure the margin. According to the CD standard, the thickness of the protection layer is 1.2 mm. Additionally, according to the DVD standard, the thickness of the protection layer is 0.6 mm.

Based on such backgrounds, an optical head device and an optical information recording/reproducing device are desired, which are able to record and reproduce on a plurality types of optical recording media according to different standards. That is, an optical head device and an optical information recording/reproducing device having a compatible function are desired. In a normal optical head device, the objective lens is designed so that a spherical aberration is corrected in case of using a protection layer having certain thickness, and thus the spherical aberration remains in case of using a protection layer having other thickness. When the spherical aberration remains, the shape of the condensed spot is distorted and accordingly the recording and reproducing cannot be carried out well. Hence, as the optical head device having the compatible function, an optical head device having a plurality of objective lenses is proposed. In the optical head device, respective objective lenses are designed so that the spherical aberration is corrected in case of using respective protection layers having respective thickness. Accordingly, the recording and reproducing can be carried out well on a plurality of types of the optical recording media, by using the each objective lens specific to a type of the used optical recording medium.

As a related optical head device having two objective lenses to record and reproduce on both of the optical recording medium according to the DVD standard and the optical recording medium according to the CD standard, an optical head device is disclosed in Japanese Laid Open Patent Application (JP-A-Heisei 9-223327). FIG. 1 shows a configuration of this optical head device. The optical head device includes a semiconductor laser 35, a polarization direction switching element 36, a polarization beam splitter 37, a mirror 38, a quarter wavelength plate 39, and objective lenses 40a and 40b. The polarization direction switching element 36 includes a liquid crystal polymer, acts as a full wavelength plate not changing a polarization direction of incoming light in a case where a voltage is applied to the liquid crystal polymer, and acts as a half wavelength plate changing the polarization direction of the incoming light by 90° in a case where the voltage is not applied to the liquid crystal polymer. In addition, the objective lenses 40a and 40b are respectively designed to correct the spherical aberration when thicknesses of the protection layer are 0.6 mm and 1.2 mm.

In a case where the disk 41 is an optical recording medium according to the DVD standard, the voltage is applied to the liquid crystal polymer in the polarization direction switching element 36. In this case, a light outputted from the semiconductor laser 35 does not change the polarization direction in the polarization direction switching element 36, is inputted to the polarization beam splitter 37 as P-polarized light and almost entirely transmits through the polarization beam splitter 37, is reflected by the mirror 38, is converted by the quarter wavelength plate 39 from linear polarized light to circular polarized light, and is corrected on the disk 41 by the objective lens 40a. The reflected light from the disk 41 passes through the objective lens 40a in an opposite direction, is converted by the quarter wavelength plate 39 from circular polarized light to linear polarized light whose polarization direction is perpendicular to that of an outward path, is reflected by the mirror 38, is inputted to the polarization beam splitter 37 as S-polarized light and is almost entirely reflected, and is received by a light detector 42.

On the other hand, in a case where the disk 41 is an optical recording medium according to the CD standard, a voltage is not applied to the liquid crystal polymer in the polarization direction switching element 36. At this time, a light outputted from the semiconductor laser 35 changes the polarization direction by 90° in the polarization direction switching element 36, is inputted to the polarization beam splitter 37 as S-polarized light and is almost entirely reflected, is converted by the quarter wavelength plate 39 from linear polarized light to circular polarized light, and is corrected on the disk 41 by the objective lens 40b. The reflected light from the disk 41 passes through the objective lens 40b in an opposite direction, is converted by the quarter wavelength plate 39 from circular polarized light to linear polarized light whose polarization direction is perpendicular to that of the outward path, is inputted to the polarization beam splitter 37 as P-polarized light and almost entirely transmits through the splitter 37, and is received by the light detector 42.

As described above, in the optical head device disclosed in JP-A-Heisei 9-223327, since the light path of the outputted light from the semiconductor laser 35 is switched based on whether or not the voltage is applied to the liquid crystal polymer in the polarization direction switching element 36, a light path can be reliably switched without mechanical movement of optical components. In addition, since the voltage applied to the liquid crystal polymer is approximately 0 to 5 volts, the light path can be switched with low-cost without using a circuit for generating a high voltage.

Meanwhile, in recent years, a next generation standard is proposed or put into practical use, in which the wavelength of the light source is further shortened and the numerical aperture of the objective lens is further increased in order to further improve the recording density. According to the standard called HD DVD (high definition DVD) standard having 15 G to 20 Gbyte in capacity, the wavelength of the light source is approximately 405 nm and the numerical aperture is 0.65. Additionally, in the standard called BD (blu-ray disk) having 23.3 G to 27 Gbyte in capacity, the wavelength of the light source is approximately 405 nm and the numerical aperture is 0.85. According to the HD DVD standard, the thickness of the protection layer is 0.6 mm. According to the BD standard, the thickness of the protection layer is 0.1 mm.

Meanwhile, when the thickness of the protection layer in the recording medium is out of a designed value, the shape of the condensed spot is distorted by the spherical aberration to deteriorate the recording and reproducing characteristic. Since the spherical aberration is in inverse proportion to the wavelength of the light source and is in proportion to the fourth power of the numerical aperture, when the wavelength is short and the numerical aperture is large, a margin of a thickness variation in the protection layer is decreased. Accordingly, in an optical head device and an optical information recording/reproducing device according to the next generation standards in which the wavelength of the light source is further shortened and the numerical aperture is further increased in order to further improve the recording density, it is required to correct the spherical aberration caused by the thickness variation in order to ensure the margin of the thickness variation.

As a related art of an optical head device correcting the spherical aberration caused by the thickness variation, an optical head device is disclosed in Japanese Laid-Open Patent Application (JP-P2002-319172). FIG. 2 shows a configuration of this optical head device. A light outputted from a semiconductor laser 43 is adjusted to be parallel light with a collimator lens 44, is inputted to a polarization beam splitter 45 as P-polarized light and almost entirely transmits through the polarization beam splitter 45, passes through liquid crystal optical elements 46a and 46b, is converted by a quarter wavelength plate 47 from linear polarized light to circular polarized light, and is collected on the disk 49 by the objective lens 48. The light reflected from the disk 49 passes through the objective lens 48 in an opposite direction, is converted by the quarter wavelength plate 47 from circular polarized light to linear polarized light whose polarization direction is perpendicular to that of the outward path, passes through the liquid crystal optical elements 46b and 46a, is inputted to the polarization beam splitter 45 as S-polarized light and is almost entirely reflected, passes through a convex lens 50, and is received by a light detector 51.

FIG. 3 is a cross sectional view showing the liquid crystal optical elements 46a and 46b. The liquid crystal optical element 46a and the liquid crystal optical element 46b overlap with each other. The liquid crystal optical element 46a has a configuration where a liquid crystal polymer layer 54a is sandwiched between a glass substrate 52a and a glass substrate 52b. On surfaces of glass substrates 52a and 52b facing to liquid crystal polymer layer 54a, transparent electrodes 53a and 53b for applying a voltage to the liquid crystal polymer layer 54a are formed, respectively. One of the transparent electrodes 53a and 53b is a patterned electrode and the other one is a full face electrode. The liquid crystal optical element 46b has a configuration in which a liquid crystal polymer layer 54b is sandwiched between a glass substrate 52c and a glass substrate 52d. On surfaces of glass substrates 52c and 52d facing to the liquid crystal polymer layer 54b, transparent electrodes 53c and 53d for applying a voltage to the liquid crystal polymer layer 54b are formed, respectively. One of the transparent electrodes 53c and 53d is a patterned electrode and the other one is a full face electrode.

The liquid crystal optical element 46a acts only for linear polarized light in the outward path, and the liquid crystal optical element 46b acts only for linear polarized light in the return path. Then, an appropriate voltage is applied to the liquid crystal polymer layer 54a, thereby the spherical aberration in the outward path is cancelled. An appropriate voltage is applied to the liquid crystal polymer layer 54b, thereby a spherical aberration in the return path is cancelled. In this manner, the spherical aberration is corrected.

In addition, as disclosed in Japanese Laid-Open Patent Application (JP-P2005-158171), an optical head device is known, in which the spherical aberration caused by the thickness variation in the protection layer is corrected by using an expander lens configured by combining a concave lens and a convex lens. When a clearance between the concave lens and the convex lens is changed, a magnification of the objective lens changes, thereby the spherical aberration of the objective lens changes. Accordingly, the clearance between the concave lens and the convex lens is appropriately adjusted to cancel spherical aberrations of the outward path and the return path in the objective lens. In this manner, the spherical aberrations are corrected.

Additionally, in National publication of translated version of PCT Application JP-P 2006-512708, an optical scanning device is disclosed, which includes an irradiation source for generating an irradiation beam and an objective system for converging the irradiation beam on an information layer and scans the information layer in an optical recording carrier. This device includes an optical element, and the optical element is at least two adjoining materials and includes a material having a shaped interface between the materials. A first material is birefringent and a second material has a refractive index substantially equal to a refractive index of the birefringent material at a predetermined angle.

### DISCLOSURE OF INVENTION

An object of the present invention is to provide an optical head device, an optical information recording/reproducing device, and an optical information recording/reproducing method which enable to dynamically correct spherical aberrations in a plurality of optical recording media having different optical characteristics, with a simple configuration.

In an aspect of the present invention, an optical head device includes: a first objective lens; a second objective lens; a light detector; a polarization beam splitter; a polarization direction switching means; and a spherical aberration correction means. Operated objects of the optical head device are a first and second types of optical recording media which are different conditions in a used optical system. The first objective lens collects outputted light outputted from a light source on the first type of optical recording medium. The second objective lens collects outputted light outputted from the light source on the second type of optical recording medium. The light detector receives a reflected light collected by the first objective lens and reflected by the first type of optical recording medium, and receives a reflected light collected by the second objective lens and reflected by the second type of optical recording medium. The polarization beam splitter splits a light path of the outputted light from the light source to the first objective lens and a light path from the light source to the second objective lens, and synthesizes a light path of the reflected light from the first objective lens to the light detector and a light path of the reflected light from the second objective lens to the light detector. The polarization direction switching means switches whether or not to change a polarization direction in a linear polarized light toward the polarization beam splitter from the light source and a polarization direction in a linear polarized light toward the light detector from the polarization beam splitter by 90°. The spherical aberration correction means acts on both of the outputted lights passing from the light source to the first and second types of optical recording media and corrects the spherical aberration in the light path of the outputted light, and acts on both of the outputted lights passing from the first and second types of optical recording media to the light detector and corrects the spherical aberration in the light path of the reflected light.

In another aspect of the present invention, an optical information recording/reproducing method includes: a light collection step; a light detection step; a split and synthesis step; a polarization direction switching step; and a spherical aberration correction step. In the light collection step, outputted light outputted from a light source is collected on an optical recording medium with a plurality of objective lenses, respectively. The plurality of the objective lenses is designed to fit different types of the optical recording media. At the light detection step, reflected light reflected by the optical recording medium is received by a light detector. At a split and synthesis step, a light path of the outputted light and a light path of the reflected light are split and synthesized. At the polarization direction switching step, polarization directions in the outputted light and the reflected light are switched based on a type of the optical recording medium. Specifically, operation is switched whether or not to change the polarization directions of the outputted light and the reflected light by 90°. At the spherical aberration correction step, spherical aberration in the outputted light path and spherical aberration in the reflected light path are corrected in common.

According to the present invention, the optical head device, the optical information recording/reproducing device, and the optical information recording/reproducing method are provided, which act on both of a plurality of types of the optical recording media having different optical characteristics and are able to record and reproduce on the plurality types of optical recording media by employing a plurality of objective lenses to provide a pair of spherical aberration correction means for correcting spherical aberration in the outward path and a return path at the same time in an optical system. The optical head device, the optical information recording/reproducing device, and the optical information recording/reproducing method are able to correct spherical aberration for any optical recording media, with a simple configuration.

### BRIEF DESCRIPTION OF DRAWINGS

A purpose, an effect, and a characteristic of the above-mentioned invention will be more clarified based on Description and attached drawings.

FIG. 1 is a view showing a configuration of a related optical head device which records and reproduces on two types of optical recording media.

FIG. 2 is a view showing a configuration of a related optical head device which corrects spherical aberration caused by a thickness variation of a protection layer in an optical recording medium.

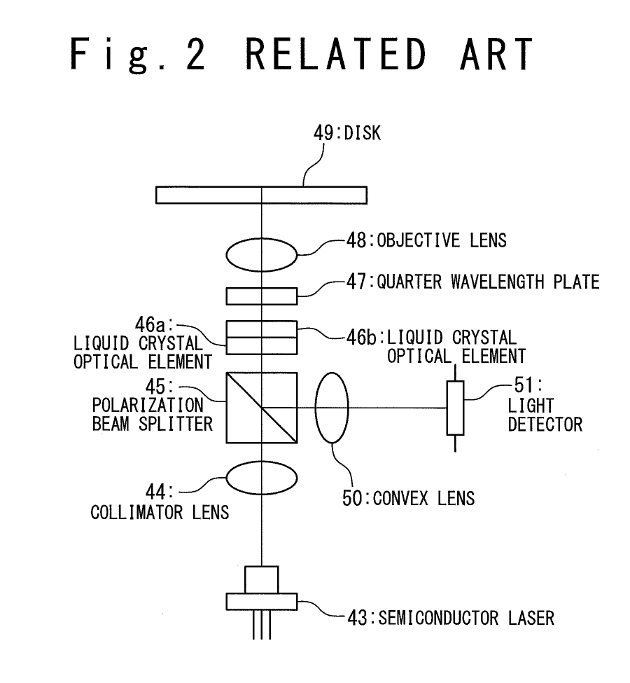

FIG. 3 is a cross sectional view showing a liquid crystal optical element in a related optical head device.

FIG. 4 is a view showing a configuration of an optical head device according to a first exemplary embodiment of the present invention.

FIGS. 5A to 5B are cross sectional views showing a polarization direction switching element according to the first exemplary embodiment of the present invention.

FIGS. 6A to 6C are cross sectional views showing a liquid crystal lens according to the first exemplary embodiment of the present invention.

FIG. 7 is a view showing a configuration of an optical head device according to a second exemplary embodiment of the present invention.

FIG. 8 is a view showing a configuration of an optical information recording/reproducing device according to a third exemplary embodiment of the present invention.

FIG. 9 is a view showing a configuration of an optical information recording/reproducing device according to a fourth exemplary embodiment of the present invention.

### BEST MODE FOR CARRYING OUT THE INVENTION

Referring to drawings, exemplary embodiments of the present invention will be explained below.

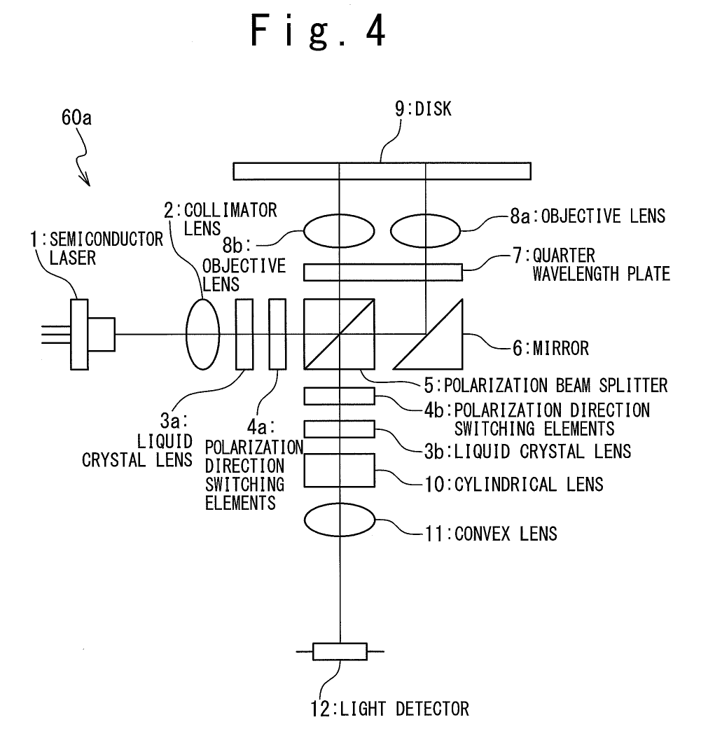

FIG. 4 shows a configuration of an optical head device according to a first exemplary embodiment of the present invention. In the present exemplary embodiment, an optical head device 60a includes two objective lenses, which are able to record and reproduce on optical recording media according to both of the HD DVD standard and the BD standard. The objective lenses 8a and 8b are designed so as to correct spherical aberrations when thicknesses of protection layers are 0.6 mm and 0.1 mm, respectively. A polarization beam splitter 5 splits a light path of outputted light outputted from a semiconductor laser 1 which is a light source into a light path from the semiconductor laser 1 to the objective lens 8a and a light path from the semiconductor laser 1 to the objective lens 8b. In addition, the polarization beam splitter 5 synthesizes a light path from the objective lens 8a to a light detector 12 and a light path from the objective lens 8b to the light detector 12, regarding reflection lights from a disk 9 that is an optical recording medium. A polarization direction switching element 4a that is a polarization direction switching means for the outward path and a polarization direction switching element 4b that is a polarization direction switching means for the return path respectively include a liquid crystal polymer. Accordingly, the polarization direction switching elements 4a and 4b act as full wavelength plates not changing a polarization direction of incoming light when a voltage is applied to the liquid crystal plate, and act as half wavelength plates changing the polarization of the incoming light by 90° when the voltage is not applied to the liquid crystal polymer. A liquid crystal lens 3a as the spherical aberration correction means for the outward path and a liquid crystal lens 3b as the spherical aberration correction means for the return path have functions for correcting spherical aberrations in the outward path and the return path, respectively.

In a case where the disk 9 is an optical recording medium according to the HD DVD standard, the voltage is applied to the liquid crystal polymers in the polarization direction switching elements 4a and 4b. In this case, the outputted light from the semiconductor laser 1 is adapted to be parallel light with a collimator lens 2, passes through the liquid crystal lens 3a, is not changed in a polarization direction by the polarization direction switching element 4a, is inputted to the polarization beam splitter 5 as P-polarized light and almost entirely transmits through the polarization beam splitter 5, is reflected by a mirror 6, is converted by a quarter wavelength plate 7 from linear polarized light to circular polarized light, and is collected on the disk 9 by the objective lens 8a. The reflected light from the disk 9 passes through the objective lens 8a in an opposite direction, is converted by the quarter wavelength plate 7 from circular polarized light to linear polarized light whose polarization direction is perpendicular to the outward path, is reflected by the mirror 6, is inputted to the polarization beam splitter 5 as S-polarized light and is almost entirely reflected, is not changed in polarization direction by the polarization direction switching element 4b, passes through the liquid crystal lens 3b, passes through a cylindrical lens 10 and a convex lens 11, and is received by the light detector 12.

On the other hand, in a case where the disk 9 is the optical recording medium according to the BD standard, the voltage is not applied to the liquid crystal polymers in the polarization direction switching elements 4a and 4b. In this case, the outputted light outputted from the semiconductor laser 1 is adjusted to be parallel light with the collimator lens 2, passes through the liquid crystal lens 3a, changes the polarization direction by 90° in the polarization direction switching element 4a, is inputted to the polarization beam splitter 5 as S-polarized light and is almost entirely reflected, is converted by the quarter wavelength plate 7 from linear polarized light to circular polarized light, and is collected on the disk 9 by the objective lens 8b. The reflected light from the disk 9 passes through the objective lens 8b in an opposite direction, is converted by the quarter wavelength plate 7 from circular polarized light to linear polarized light whose polarization direction is perpendicular to the outward path, is inputted to the polarization beam splitter 5 as P-polarized light and almost entirely transmits through the polarization beam splitter 5, changes the polarization direction by 90° in the polarization direction switching element 4b, passes through the liquid crystal lens 3b, passes through the cylindrical lens 10 and the convex lens 11, and is received by the light detector 12.

The light detector 12 is provided at an intermediate position between two focal lines formed by the cylindrical lens 10 and the convex lens 11, and has four light-receiving parts separated by a separation line corresponding to a radius direction of the disk 9 and a separation line corresponding to a tangential direction of the disk 9. A focus error signal, a track error signal, and a reproduction signal that is a mark/space signal recorded in the disk 9 are detected based on voltage signals outputted from the four light-receiving parts. The focus error signal is detected with a commonly-known astigmatism method, and the track error signal is detected with the commonly-known push-pull method. The reproduction signal is detected from a high-frequency component in a summation of the voltage signals outputted from the four light-receiving parts.

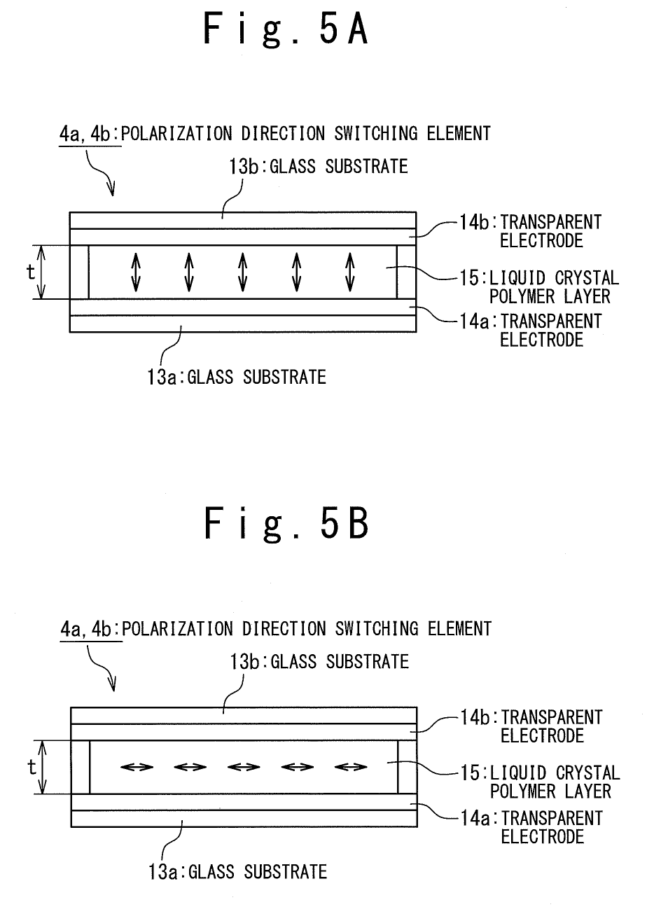

FIGS. 5A and 5B are cross sectional views showing the polarization direction switching elements 4a and 4b. The polarization direction switching elements 4a and 4b have a configuration where a liquid crystal polymer layer 15 is sandwiched between a glass substrate 13a and a glass substrate 13b. Transparent electrodes 14a and 14b for applying an alternating-current voltage to the liquid crystal polymer layer 15 are respectively formed on the surfaces of glass substrates 13a and 13b facing to the liquid crystal polymer layer 15. Arrowed lines in the drawings show a longitudinal direction of the liquid crystal polymer in the liquid crystal polymer layer 15. The liquid crystal polymer layer 15 has a uniaxial refractive index anisotropy whose optical axis is along the longitudinal direction of the liquid crystal polymer. When a refractive index with a polarization component parallel to the longitudinal direction of the liquid crystal polymer (an extraordinary light component) is represented by “ne” and a refractive index with a polarization component perpendicular to the longitudinal direction of the liquid crystal polymer (an ordinary light component) is represented by “no”, the “ne” is larger than the “no”.

When an alternating-current voltage whose effective value is 5 volts is applied to the liquid crystal polymer layer 15, the longitudinal direction of the liquid crystal polymer in the liquid crystal polymer layer 15 is almost parallel to the optical axis of incoming light as shown in FIG. 5A. Accordingly, the reflective index of the liquid crystal polymer layer 15 with the incoming light becomes the “no”. On this occasion, the polarization direction switching elements 4a and 4b act as a full wavelength plate that does not change a polarization direction of the incoming light. Meanwhile, in a case where the voltage is not applied to the liquid crystal polymer layer 15, the longitudinal direction of the liquid crystal polymer in the liquid crystal polymer layer 15 is almost perpendicular to the optical axis of the incoming light as shown in FIG. 5B. Accordingly, the reflective index of the liquid crystal polymer layer 15 is the “ne” with extraordinary light component and is the “no” with the ordinary light component. In a cross-section perpendicular to the optical axis, an angle formed between the longitudinal direction of the liquid crystal polymer in the liquid crystal polymer layer 15 and a direction parallel to a surface of this paper is 45°, and an angle formed between the longitudinal direction and a direction perpendicular to the paper surface is 45°. Here, when a wavelength of the incoming light is represented by λ and a thickness of the liquid crystal polymer layer 15 is represented by t, a value of the thickness t is set to satisfy “2π(ne−no)t/λ=π”. In addition, the polarization direction of the incoming light toward the polarization direction switching elements 4a and 4b are parallel or perpendicular to the paper surface. At this time, the polarization direction switching elements 4a and 4b act as a half wavelength plate for changing the polarization direction of the incoming light by 90°.

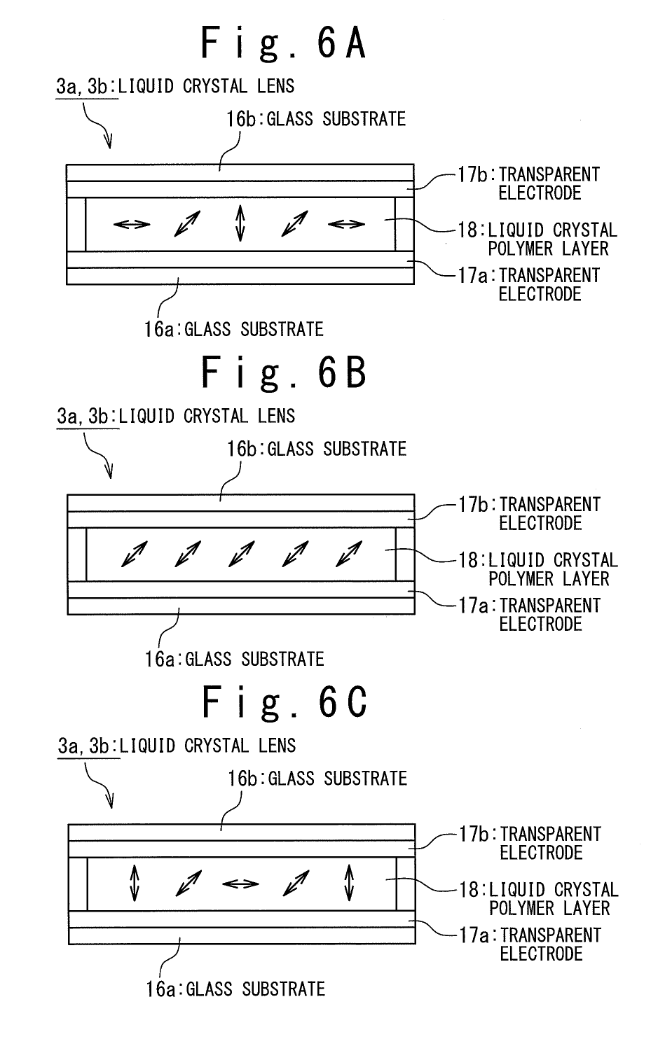

FIGS. 6A to 6C are cross sectional views showing the liquid crystal lenses 3a and 3b. The liquid crystal lenses 3a and 3b have a configuration where a liquid crystal polymer layer 18 is sandwiched between the glass substrate 16a and the glass substrate 16b. Transparent electrodes 17a and 17b for applying an alternating-current voltage to the liquid crystal polymer layer 18 are formed on surfaces of glass substrates 16a and 16b facing to the liquid crystal polymer layer 18, respectively. One of the transparent electrodes 17a and 17b is a patterned electrode and the other one is a full face electrode. An effective value of the alternating-current voltage applied to the liquid crystal polymer layer 18 can be differed between a peripheral portion and a central portion, such as 2.5+α volts in a central portion and 2.5−α volts in a peripheral portion. Arrowed lines in the drawings show a longitudinal direction of the liquid crystal polymer in the liquid crystal polymer layer 18. The liquid crystal polymer layer 18 has a uniaxial refractive index anisotropy whose optical axis is along the longitudinal direction of the liquid crystal polymer. When the refractive index with a polarization component parallel to the longitudinal direction (the extraordinary light component) is represented by “ne” and the refractive index with a polarization component perpendicular to the longitudinal direction (the ordinary light component) is represented by “no”, the “ne” is larger than the “no”. Here, the polarization directions of incoming light to the liquid crystal lenses 3a and 3b are parallel to the paper surface.

In a case of “0 volt<α<1 volt”, as shown in FIG. 6A, the longitudinal direction of the liquid crystal polymer is varied between the periphery portion and the central portion, approximates to a direction parallel to the optical axis of the incoming light in the central portion, and approximates to a direction perpendicular to the optical axis of the incoming light and parallel to the paper surface in the periphery portion. Accordingly, the refractive index of the liquid crystal polymer layer 18 with the incoming light is varied between the peripheral portion and the central portion, approximates to the “no” in the central portion, and approximates to the “ne” in the peripheral portion. At this time, the liquid crystal lenses 3a and 3b act as a concave lens for the incoming light. The larger an absolute value of the “α” is, the smaller an absolute value of a focal length of the concave lens is.

In a case of “α=0”, as shown in FIG. 6B, in both of the center portion and the peripheral potion, the longitudinal directions are along an intermediate direction between a direction parallel to the optical axis of the incoming light and a direction perpendicular to the optical axis of the incoming light and parallel to the paper surface.

Accordingly, in both of the center portion and the peripheral potion, the refractive index of the liquid crystal polymer layer 18 with the incoming light becomes an intermediate value between the “ne” and the “no”. At this time, the liquid crystal lenses 3a and 3b do not act as a lens with the incoming light.

In a case of “−1 volt<α<0 volt”, as shown in FIG. 6C, the longitudinal direction of the liquid crystal polymer is varies between the periphery portion and the central portion, moves closer to the direction perpendicular to the optical axis of the incoming light and parallel to the paper surface in the central portion, and moves closer to the direction parallel to the optical axis of the incoming light in the periphery portion. Accordingly, the refractive index of the liquid crystal polymer layer 18 with the incoming light is varied between the peripheral portion and the central portion, moves closer to the “ne” in the central portion, and moves closer to the “no” in the peripheral portion. At this time, the liquid crystal lenses 3a and 3b act as a convex lens with the incoming light. The larger the absolute value of the “α” is, the smaller an absolute value of a focal length of the convex lens is.

Since the polarization direction of the light toward the polarization direction switching element 4a from the semiconductor laser 1 in the outward path is the same in both cases of using the optical recording media according to the HD DVD and the BD, the liquid crystal lens 3a can be provided so as to be parallel to the paper surface of FIGS. 6A to 6C. In addition, since the polarization direction of the light in the return path toward the light detector 12 from the polarization direction switching element 4b is the same in both cases of using the optical recording media according to the HD DVD and the BD, the liquid crystal lens 3b can be provided so as to be parallel to the paper surfaces of FIGS. 6A to 6C.

When a value of “α” of the liquid crystal polymer in the liquid crystal lens 3a changes, magnifications of the objective lenses 8a and 8b in the outward path change and accordingly spherical aberration in the objective lenses 8a and 8b change. Thus, when the value of “α” is appropriately adjusted, the liquid crystal lens 3a cancels spherical aberration in the outward path in the objective lenses 8a and 8b. In addition, when the value of “α” of the liquid crystal polymer of the liquid crystal lens 3b changes, magnifications of the objective lenses 8a and 8b in the return path are changed and accordingly spherical aberration in the objective lenses 8a and 8b is changed. Thus, when the value of “α” is appropriately adjusted, the liquid crystal lens 3b cancels the spherical aberration in the return path in the objective lenses 8a and 8b. In this manner, spherical aberrations in the outward path and the return path can be dynamically corrected in both optical recording media according to the HD DVD and the BD.

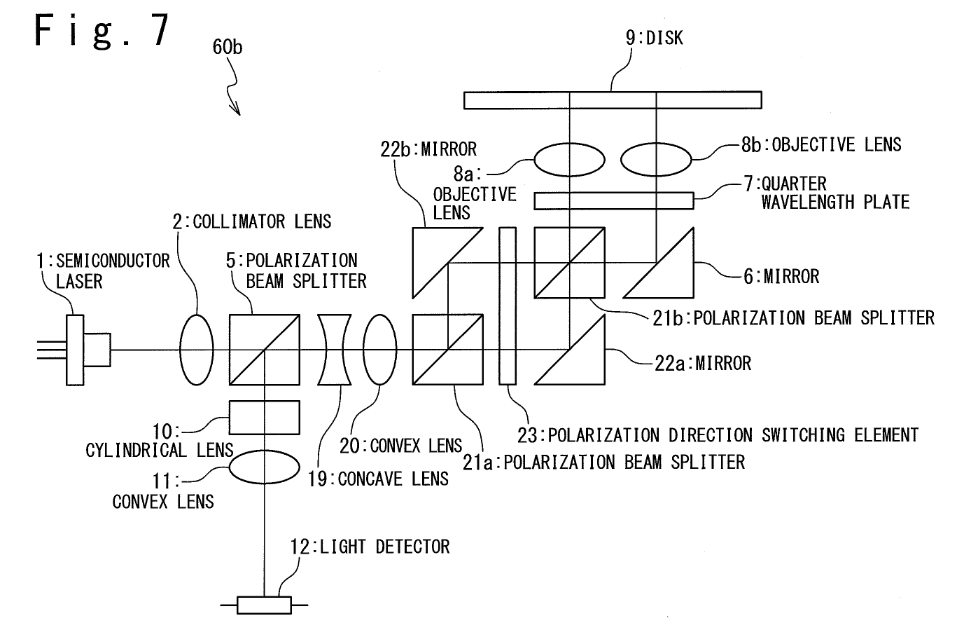

FIG. 7 shows a configuration of an optical head device according to a second exemplary embodiment of the present invention. In the present exemplary embodiment, the optical head device 60b includes two objective lenses which are able to record and reproduce on optical recording media according to both of the HD DVD standard and the BD standard. The objective lenses 8a and 8b are designed so as to correct spherical aberrations for protection layers of 0.6 mm-thickness and 0.1 mm-thickness, respectively. A polarization beam splitter 21b splits a light path of an outputted light outputted from a semiconductor laser 1 that is a light source into a light path from the semiconductor laser 1 to the objective lens 8a and a light path from the semiconductor laser 1 to the objective lens 8b. In addition, the polarization beam splitter 21b synthesizes a light path from the objective lens 8a to a light detector 12 and a light path from the objective lens 8b to the light detector 12, regarding lights reflected by the disk 9 that is an optical recording medium. A polarization direction switching element 23, which is a polarization direction switching means, includes a liquid crystal polymer. The polarization direction switching element 23 acts as full wavelength plates for changing polarization direction of the incoming light in a case where a voltage is applied to the liquid crystal plate, and acts as half wavelength plate changing the polarization direction of the incoming light by 90° when the voltage is not applied to the liquid crystal plate. An expander lens, which is a spherical aberration correction means including a concave lens 19 and a convex lens 20, has a function for correcting the spherical aberrations in the outward path and the return path. The polarization beam splitter 5, which is a light splitting means, splits the light in the outward path from the semiconductor laser 1 to the objective lens 8a or 8b and the light in the return path from the objective lens 8a or 8b to the light detector 12.

In the case where the disk 9 is the optical recording medium according to the HD DVD standard, a voltage is applied to the liquid crystal polymer in the polarization direction switching element 23. On this occasion, the outputted light from the semiconductor laser 1 is adapted to be a parallel light with the collimator lens 2, is inputted to the polarization beam splitter 5 as P-polarized light and almost entirely transmits through the polarization beam splitter 5, passes through the concave lens 19 and the convex lens 20, and is inputted to the polarization beam splitter 21a as P-polarized light and almost entirely transmits through the splitter. The transmitting light does not change the polarization direction in the polarization direction switching element 23, is reflected by a mirror 22a, and is inputted to the polarization beam splitter 21b as P-polarized light and almost entirely transmits through the polarization beam splitter 21b, is converted by the quarter wavelength plate 7 from linear polarized light to circular polarized light, and is collected on the disk 9 by the objective lens 8a. The reflected light from the disk 9 passes through the objective lens 8a in an opposite direction, is converted by the quarter wavelength plate 7 from circular polarized light to linear polarized light whose polarization direction is perpendicular to that of the outward path, is inputted to the polarization beam splitter 21b as S-polarized light and is almost entirely reflected, does not change the polarization direction in the polarization direction switching element 23, and is reflected by the mirror 22b. The light reflected by the mirror 22b is inputted to the polarization beam splitter 21a as S-polarized light and is almost entirely reflected, passes through the convex lens 20 and the concave lens 19, is inputted to the polarization beam splitter 5 as S-polarized light and is almost entirely reflected, passes through the cylindrical lens 10 and the convex lens 11, and is received by the light detector 12.

On the other hand, in the case where the disk 9 is the optical recording medium according to the BD standard, a voltage is not applied to the liquid crystal polymers in the polarization direction switching element 23. On this occasion, the outputted light from the semiconductor laser 1 is adapted to be parallel light with the collimator lens 2, is inputted to the polarization beam splitter 5 as P-polarized light and almost entirely transmits through the polarization beam splitter 5, passes through the concave lens 19 and the convex lens 20, is inputted to the polarization beam splitter 21a as P-polarized light and almost entirely transmits through the polarization beam splitter 21a, and changes the polarization direction by 90° in the polarization direction switching element 23. The light changed in the polarization direction is reflected by the mirror 22a, is inputted to the polarization beam splitter 21b as S-polarized light and is almost entirely reflected, is reflected by the mirror 6, is converted by the quarter wavelength plate 7 from linear polarized light to circular polarized light, and is collected on the disk 9 by the objective lens 8b. The reflected light from the disk 9 passes through the objective lens 8b in an opposite direction, is converted by the quarter wavelength plate 7 from circular polarized light to linear polarized light whose polarization direction is perpendicular to that of the outward path, is reflected by the mirror 6, is inputted to the polarization beam splitter 21b as P-polarized light and almost entirely transmits through the polarization beam splitter 21b, and changes the polarization direction by 90° in the polarization direction switching element 23. The light changed in the polarization direction is reflected by the mirror 22b, is inputted to the polarization beam splitter 21a as S-polarized light and is almost entirely reflected, passes through the convex lens 20 and the concave lens 19, is inputted to the polarization beam splitter 5 as S-polarized light and is almost entirely reflected, passes through the cylindrical lens 10 and the convex lens 11, and is received by the light detector 12.

The light detector 12 is provided at an intermediate position between two focal lines formed by the cylindrical lens 10 and the convex lens 11. The light detector 12 has four light-receiving parts separated by a separation line corresponding to a radius direction of the disk 9 and a separation line corresponding to a tangential line of the disk 9. A focus error signal, a track error signal, and a reproduction signal that is a mark/space signal recorded in the disk 9 are detected based on voltage signals outputted from the four light-receiving parts. The focus error signal is detected with the commonly-known astigmatism method, and the track error signal is detected with the commonly-known push-pull method. The reproduction signal is detected from a high-frequency component in a summation of the voltage signals outputted from the four light-receiving parts.

A cross sectional view of the polarization direction switching element 23 is the same as those shown in FIGS. 5A to 5B. In a case where an alternating-current voltage whose effective value is 5 volts is applied to the liquid crystal polymer layer 15, the polarization direction switching element 23 acts as a full wavelength plate changing the polarization direction of the incoming light. Meanwhile, in a case where the voltage is not applied to the liquid crystal polymer layer 15, the polarization direction switching element 23 acts as a half wavelength plate changing the polarization direction of the incoming light by 90°.

The polarization direction of the light toward the polarization direction switching element 23 from the semiconductor laser 1 in the outward path is same in both cases of using the optical recording medium according to the HD DVD and using the optical recording medium according the BD. The polarization direction of the light toward the light detector 12 from the polarization direction switching element 23 in the return path is same in both cases of using the optical recording medium according to the HD DVD and using the optical recording medium according to the BD. On this occasion, since the polarization direction of the light in the outward path and the polarization direction of the light in the return path cross at right angles each other, the light in the outward path and the light in the return path are synthesized by the polarization beam splitter 21a. Accordingly, the expander lenses (the concave lens 19 and the convex lens 20) can be provided between the polarization beam splitter 5 and 21a which are common light paths between the outward path and the return path. When a clearance between the concave lens 19 and the convex lens 20 changes, magnifications of the objective lenses 8a and 8b are changed and accordingly the spherical aberrations in the objective lenses 8a and 8b are changed. Thus, when the clearance between the concave lens 19 and the convex lens 20 is appropriately adjusted, spherical aberrations in the outward path and the return path are canceled in the objective lenses 8a and 8b. In this manner, spherical aberrations in the outward path and the return path can be simultaneously corrected in optical recording media according to both of the HD DVD and the BD.

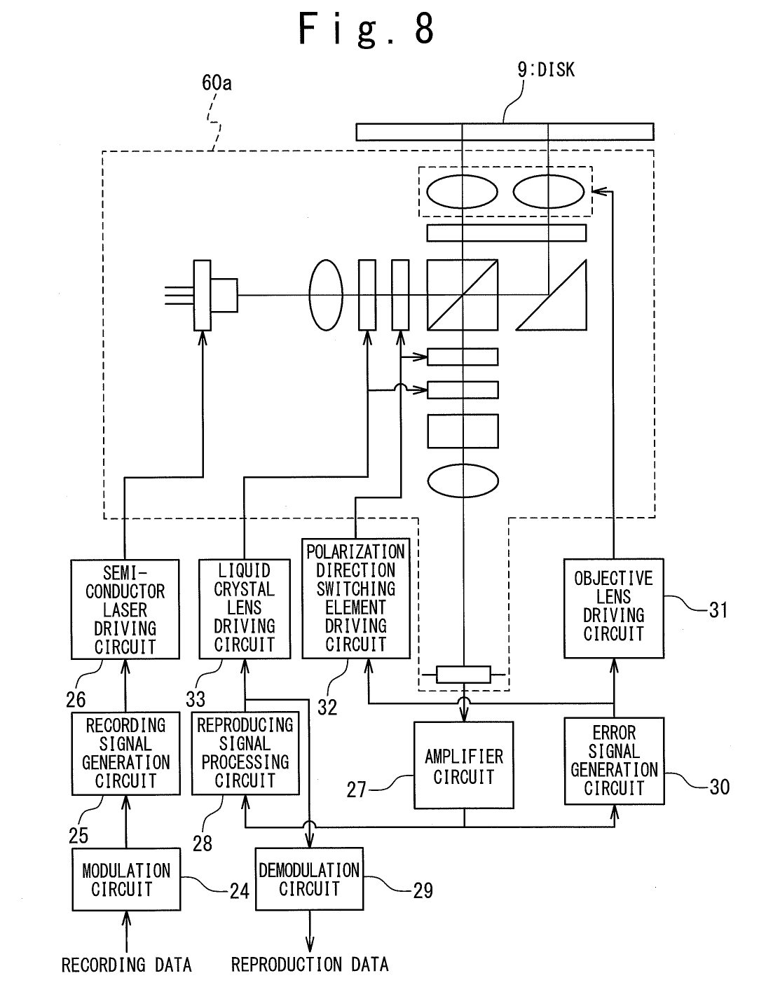

FIG. 8 shows a configuration of an optical information recording/reproducing device according to a third exemplary embodiment of the present invention. In the present exemplary embodiment, the optical information recording/reproducing device includes the optical head device 60a described in the first exemplary embodiment, a modulation circuit 24, a recording signal generation circuit 25, a semiconductor laser drive circuit 26, an amplifier circuit 27, a reproducing signal processing circuit 28, a demodulation circuit 29, an error signal generation circuit 30, an objective lens driving circuit 31, a polarization direction switching element driving circuit 32, and a liquid crystal lens driving circuit 33. These circuits are controlled by a controller (not shown in the drawing). The polarization direction switching element driving circuit 32, which is a polarization direction switching means driving circuit, drives the polarization direction switching elements 4a and 4b, and switches whether or not to change a polarization direction of the incoming light toward the polarization direction switching elements 4a and 4b by 90° based on which optical recording media is used between the HD DVD and the BD. The liquid crystal lens driving circuit 33, which is a spherical aberration correction means driving circuit, drives the liquid crystal lens 3a and 3b to correct spherical aberration in the outward path and the return path.

When data is recorded to the disk 9, the modulation circuit 24 modulates the data to be recorded to the disk 9 in accordance with a modulation rule. The recording signal generation circuit 25 generates a recording signal to drive the semiconductor laser 1 in accordance with a recording strategy based on the signal modulated by the modulation circuit 24. Based on the recording signal generated by the recording signal generation circuit 25, the semiconductor laser driving circuit 26 supplies an electric current based on the recording signal to the semiconductor laser 1 and drive the semiconductor laser 1. On the other hand, when data is reproduced from the disk 9, the semiconductor laser driving circuit 26 supplies a constant current to the semiconductor laser 1 so that a power of outputted light from the semiconductor laser 1 becomes constant, and drives the semiconductor laser 1. The amplifier circuit 27 amplifies a voltage signal outputted from each light-receiving part of the light detector 12.

In a case where data is reproduced from the disk 9, the reproducing signal processing circuit 28 generates a reproducing signal based on the voltage signal amplified by the amplifier circuit 27, equalizes waveforms, and binarizes. The demodulation circuit 29 demodulates a signal binarized by the reproducing signal processing circuit 28 in accordance with a demodulation rule. Based on the voltage signal amplified by the amplifier circuit 27, the error signal generation circuit 30 generates a focus error signal and a track error signal used for driving the objective lenses 8a and 8b. Based on the focus error signal and the track error signal generated by the error signal generation circuit 30, the objective lens driving circuit 31 supplies an electric current based on the focus error signal and the track error signal to an actuator (not shown in the drawings), and drives the objective lenses 8a and 8b. Moreover, the optical head device 60a is driven to a radius direction of the disk 9 by a positioner (not shown in the drawings). The disk 9 is driven to be rotated by a spindle (not shown in the drawings).

The polarization direction switching element driving circuit 32 drives the polarization direction switching elements 4a and 4b based on the focus error signal generated by the error signal generation circuit 30. Specifically, the polarization direction switching element driving circuit 32 checks whether the thickness of protection layer is 0.6 mm or 0.1 mm based on intervals of zero cross points of the focus error signals sent from a disk surface and a recording surface of the disk 9. When the thickness of the protection layer is 0.6 mm, the disk 9 is judged to be the optical recording medium according to the HD DVD standard and the polarization direction switching element driving circuit 32 applies a voltage to the liquid crystal polymers in the polarization direction switching elements 4a and 4b so as not to change the polarization direction of the incoming light toward the polarization direction switching elements 4a and 4b. On the other hand, when the thickness of the protection layer is 0.1 mm, the disk 9 is judged to be the optical recording medium according to the BD standard, the polarization direction switching element driving circuit 32 does not apply a voltage to the liquid crystal polymers in the polarization direction switching elements 4a and 4b, and the polarization direction of the incoming light toward the polarization direction switching elements 4a and 4b is changed by 90°. The liquid crystal lens driving circuit 33 drives the liquid crystal lenses 3a and 3b based on the reproducing signal inputted from the reproducing signal processing circuit 28. Specifically, in order to improve a quality evaluation index of the reproducing signal to be the best, the liquid crystal lens driving circuit 33 appropriately adjusts “α” of the liquid crystal lenses 3a and 3b with the liquid crystal polymer to dynamically correct the spherical aberrations in the outward path and the return path.

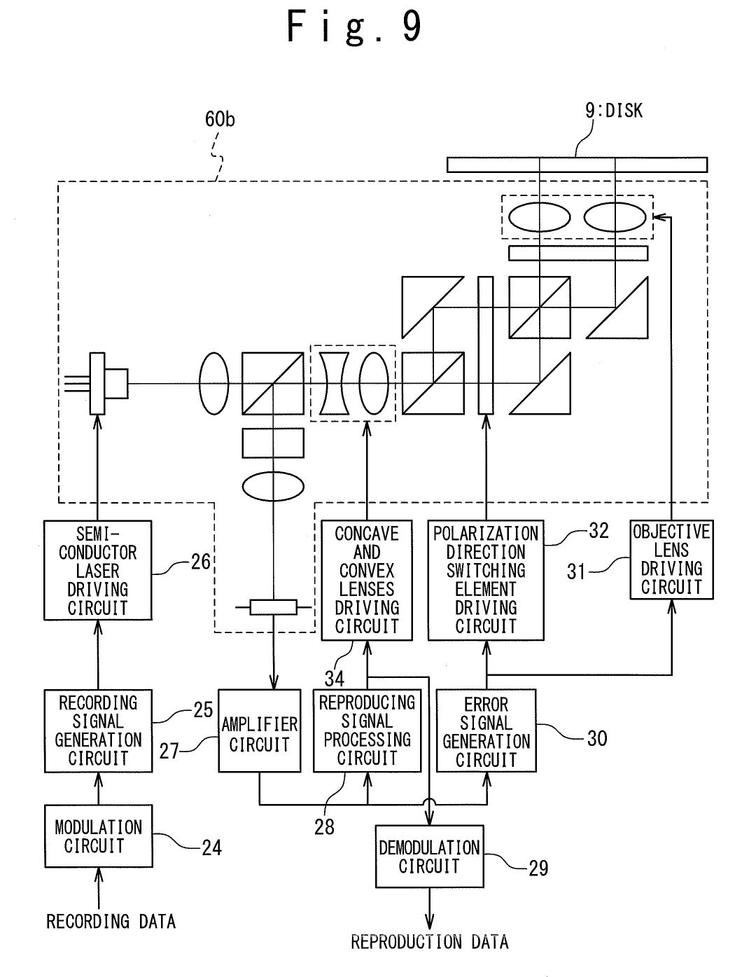

FIG. 9 shows a configuration of an optical information recording/reproducing device according to a fourth exemplary embodiment of the present invention. In the present exemplary embodiment, the optical information recording/reproducing device includes the optical head device 60b described in the second exemplary embodiment, a modulation circuit 24, a recording signal generation circuit 25, a semiconductor laser driving circuit 26, an amplifier circuit 27, a reproducing signal processing circuit 28, a demodulation circuit 29, an error signal generation circuit 30, an objective lens driving circuit 31, a polarization direction switching element driving circuit 32, and a concave and convex lenses driving circuit 34. These circuits are controlled by a controller (not shown in the drawings). The polarization direction switching element driving circuit 32, which is a polarization direction switching means driving circuit, drives the polarization direction switching element 23, and switches whether or not to change the polarization direction of incoming light toward the polarization direction switching element 23 by 90° based on which optical recording media is used between the HD DVD and the BD. The concave and convex lenses driving circuit 34, which is a spherical aberration correction means driving circuit, drives the concave lens 19 or the convex lens 20 to correct the spherical aberrations in the outward path and the return path.

The polarization direction switching element driving circuit 32 drives the polarization direction switching element 23 based on the focus error signal inputted from the error signal generation circuit 30. Specifically, the polarization direction switching element driving circuit 32 checks whether the thickness of the protection layer is 0.6 mm or 0.1 mm based on intervals of zero cross points of the focus error signals sent from a disk surface and a recording surface of the disk 9. When the thickness of the protection layer is 0.6 mm, the disk 9 is judged to be the optical recording medium according to the HD DVD standard, and the polarization direction switching element driving circuit 32 applies a voltage to the liquid crystal polymer in the polarization direction switching element 23 not to change the polarization direction of the incoming light toward the polarization direction switching element 23. On the other hand, when the thickness of the protection layer is 0.1 mm, the disk 9 is judged to be the optical recording medium according to the BD standard, and the polarization direction switching element driving circuit 32 does not apply a voltage to the liquid crystal polymer in the polarization direction switching element 23 so that the polarization direction of the incoming light toward the polarization direction switching element 23 is changed by 90°. The concave and convex lenses driving circuit 34 drives the concave lens 19 or the convex lens 20 based on the reproducing signal supplied from the reproducing signal processing circuit 28. Specifically, in order to improve a quality evaluation index of the reproducing signal to be the best, the concave and convex lenses driving circuit 34 appropriately adjusts a clearance between the concave lens 19 and the convex lens 20 to correct spherical aberration in the outward path and the return path.

Here, it is considered to apply an optical head device described in Japanese Laid Open Patent Application (JP-A-Heisei 9-223327) to an optical head device recording and reproducing on the optical recording media according to both of the HD DVD standard and the BD standard. In this case, the correction of spherical aberration caused by the thickness variation of the optical recording medium is required for both of the recording media. Accordingly, a function for correcting spherical aberration is ensured by employing the liquid crystal optical element and the expander lens in this optical head device.

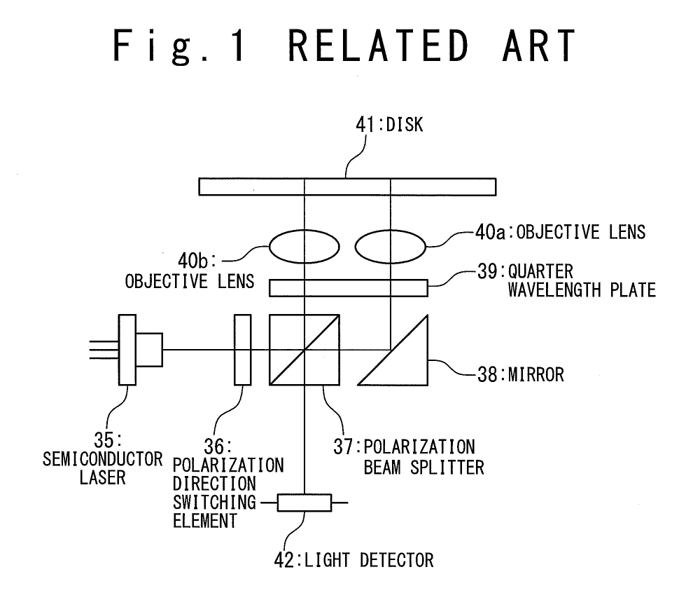

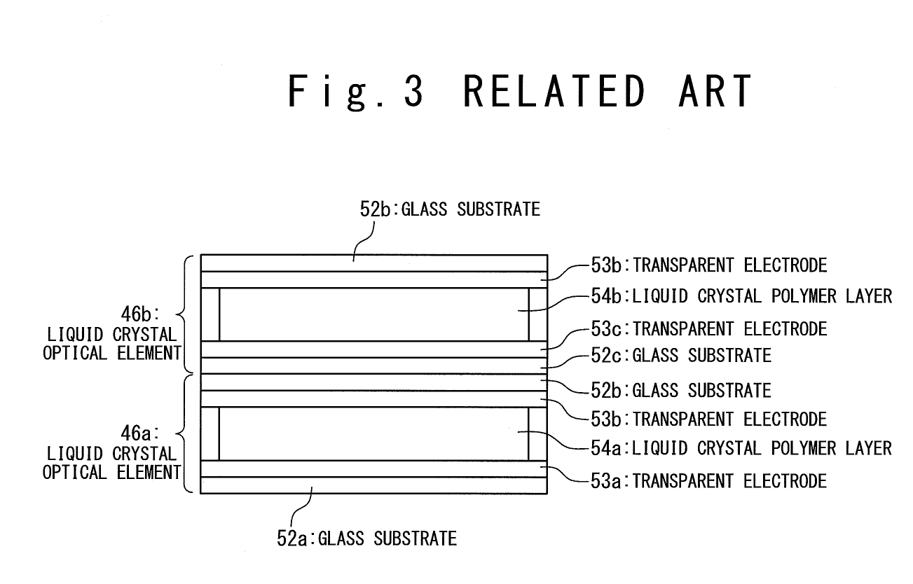

In a case where the liquid crystal optical elements 46a and 46b shown in FIG. 3 are inserted between the polarization beam splitter 37 and the quarter wavelength plate 39 in the optical head device shown in FIG. 1, two pairs of the liquid crystal optical elements 46a and 46b are required because the liquid crystal optical elements 46a and 46b are inserted in both of a light path formed between the polarization beam splitter 37 and the objective lens 40a and a light path formed between the polarization beam splitter 37 and the objective lens 40b. The liquid crystal optical element 46a may be inserted in any position in an outward path, and the liquid crystal optical element 46b may be inserted in any position in a return path. Then, it can be considered that the liquid crystal optical elements 46a and 46b are separated, the liquid crystal optical element 46a is inserted between the semiconductor laser 35 and the polarization direction switching element 36, and a liquid crystal optical element 46b is inserted between the polarization beam splitter 37 and the light detector 42. In this case, the light toward the light detector 42 from the objective lens 40a in the return path is reflected as S-polarized light by the polarization beam splitter 37 and is inputted to the liquid crystal optical element 46b, and the light toward the light detector 42 from the objective lens 40b in the return path transmits through the polarization beam splitter 37 as P-polarized light and is inputted to the liquid crystal optical element 46b. Since the liquid crystal optical element 46b acts on only one of the linear polarized lights, spherical aberration in the return path cannot be corrected in both of the two types of the optical recording media. Also, it can be considered to insert liquid crystal optical elements 46a and 46b in both of a position between the semiconductor laser 35 and the polarization direction switching element 36 and a position between the polarization beam splitter 37 and the light detector 42, however, the two pairs of the liquid crystal optical elements 46a and 46b are required.

Additionally, in FIG. 1, in a case where the expander lens is inserted between the polarization beam splitter 37 and the quarter wavelength plate 39, two pairs of the expander lenses are required because the expander lenses are inserted in both of the light path between the polarization beam splitter 37 and the objective lens 40a and the light path between the polarization beam splitter 37 and the objective lens 40b. It can be considered to insert the expander lenses in both of a position between the semiconductor laser 35 and the polarization direction switching element 36 and a position between the polarization beam splitter 37 and the light detector 42, however, two pairs of the expander lenses are required.

That is, in the case where the function for correcting the spherical aberration by adding the liquid crystal optical element and the expander lens to the optical head device described in Japanese Laid Open Patent Application (JP-A-Heisei 9-223327), two pairs of the liquid crystal optical elements or the expander lenses are required, and the optical system for correcting spherical aberration and the circuit system for driving the optical system are complicated.

As mentioned above, according to the present invention, the optical head device, the optical information recording/reproducing device, and the optical information recording/reproducing method are provided, which act on each of a plurality types of the optical recording media having different optical characteristics and are able to record and reproduce on the plurality types of the optical recording media, by including a plurality of objective lens to provide a pair of spherical aberration correction means for correcting spherical aberration in the outward and return path at the same time in an optical system. The optical head device, the optical information recording/reproducing device, and the optical information recording/reproducing method are able to correct the spherical aberration in any optical recording media, with a simple configuration.

As described above, the present invention is explained, referring to the exemplary embodiments, however, the present invention is not limited to the above-described exemplary embodiments. Various modifications, which can be understood by a person skilled in the art, can be added to the configuration and the details of the present invention, within a scope of the present invention.

1-16. (canceled)

17. An optical head device comprising:
a first objective lens configured to collect an outputted light outputted from a light source on a fist type of optical recording medium;
a second objective lens configured to collect an outputted light outputted from said light source on a second type of optical recording medium;
a light detector configured to receive a reflected light collected by said first objective lens and reflected by said first type of optical recording medium and receive a reflected light collected by said second objective lens and reflected by said second type of optical recording medium;
a polarization beam splitter configured to split a light path of said outputted light toward said first objective lens from said light source and a light path of said outputted light toward said second objective lens from said light source and synthesize a light path of said reflected light toward said light detector from said first objective lens and a light path of said reflected light toward said light detector from said second objective lens;
a polarization direction switching part for switching whether or not to change a polarization direction of a linear polarized light toward said polarization beam splitter from said light source and a polarization direction of a linear polarized light toward said light detector from said polarization beam splitter by 90°, and
a spherical aberration correction part for acting on both of outputted lights selectively passing from said light source to said first and second types of optical recording media to correct spherical aberrations in light paths of said outputted lights, and acting on both of reflected lights selectively passing from said first and second types of optical recording media to said light detector to correct spherical aberrations in light paths of said reflected lights, said spherical aberration correction part is provided on a light path of said outputted light toward said polarization direction switching part from said light source and is provided on a light path of said reflected light toward said light detector from said polarization direction switching part,
wherein a length of a light path of said outputted light is equal to a length of a light path of said reflected light, between said spherical aberration correction part and said first objective lens via said polarization direction switching part and said polarization beam splitter, and
a length of a light path of said outputted light is equal to a length of a light path of said reflected light, between said spherical aberration correction part and said second objective lens via said polarization direction switching part and said polarization beam splitter.

18. The optical head device according to claim 17, wherein said polarization direction switching part includes: a polarization direction switching part for outward path provided between said light source and said polarization beam splitter; and a polarization direction switching part for return path provided between said polarization beam splitter and said light detector, and
said spherical aberration correction part includes: a spherical aberration correction part for outward path provided between said light source and said polarization direction switching part for outward path; and a spherical aberration correction part for return path provided between said polarization direction switching part for return path and said light detector.

19. The optical head device according to claim 18, wherein said spherical aberration correction part for outward path and said spherical aberration correction part for return path include liquid crystal optical elements.

20. The optical head device according to claim 17, further comprising:
a light splitting part for splitting said outputted light toward said first or second objective lens from said light source and said reflected light toward said light detector from said first or second objective lens,
wherein said polarization direction switching part is provided between said light splitting part and said polarization beam splitter, and
said spherical aberration correction part is provided between said light splitting part and said polarization direction switching part.

21. An optical information recording/reproducing device comprising:
said optical head device according to claim 17;
a polarization direction switching part driving circuit configured to drive said polarization direction switching part so as to switch whether or not to change a polarization direction of a linear polarized light inputted to said polarization direction switching part by 90° based on which type of optical recording medium is used between said first type and said second type; and
a spherical aberration correction part driving circuit configured to drive said spherical aberration correction part so that a spherical aberration in a light path of said outputted light toward said first or second type of optical recording medium from said light source and a spherical aberration in a light path of said reflected light toward said light detector from said first or second type of optical recording medium are corrected.

22. An optical information recording/reproducing device according to claim 21, wherein said polarization direction switching part driving circuit is configured to drive said polarization direction switching part based on a type of said optical recording medium judged from a focus error signal extracted from a signal outputted from said light detector.

23. An optical information recording/reproducing device according to claim 21, wherein said spherical aberration correction part driving circuit is configured to drive said spherical aberration correction part so that a quality evaluation index of a reproducing signal reproduced from said optical recording medium becomes the best.
